(19) United States
(12) Patent Application Publication
(10) Pub. No.: US 2008/0012336 A1
(43) Pub. Date: Jan. 17, 2008

(54) Couplable flange with clamping jaws for the connection of pipes for the transport of petrochemical fluids, gases and liquefied gases

(76) Inventor: Lorenzo Bormioli, Padova (IT)

Correspondence Address: JACOBSON HOLMAN PLLC, 400 SEVENTH STREET N.W., SUITE 600, WASHINGTON, DC, 20004, US

(21) Appl. No.: 10/572,513

(22) PCT Filed: Jul. 22, 2004
(86) PCT No.: PCT/EP04/51573

§ 371 Date: Mar. 17, 2006

(30) Foreign Application Priority Data
Sep. 17, 2003 (IT) MI2003A001772

(51) Int. Cl. F16L 23/00

(52) U.S. Cl. 285/406

(57) ABSTRACT

A flange (1) for pipes for the transport of petrochemical fluids, gases and liquefied gases is described, having a bearing surface (11) for clamping jaw (3), which has a peripheral portion (2) bevelled in the direction of support of the jaw (3). Said peripheral bevelled portion (2) is preferably a curved surface.

This is a nationalization of PCT/EP2004/051573 filed 22 Jul. 2004 and published in English.

The present invention concerns a couplable flange with clamping jaws for the connection of pipes for the transport of petrochemical fluids, gases and liquefied gases.

The connection between pipes is a rather delicate operation especially in extreme conditions, as for example when one must import or export petrochemical fluids or the like between a ship and a tank located on the firm earth, between two ships in open sea or even between two lengths of pipes that extend above or underwater at a depth of several meters. Connection systems, made up of centring and coupling devices, must prevent possible losses of transported product, which can be extremely negative at economic level, for the safety of the personnel and of the installations, and highly polluting for marine and terrestrial environment in the vicinities of the installation.

In addition said connection systems must be extremely flexible and comfortable for the operator in the coupling stage and quick and in the uncoupling. This because, especially in open sea, meteorological conditions that influence the state of the sea can worsen even quickly, thus imposing the necessity of quick uncoupling of the pipe connection system, therefore compromising the safety of the transport of petrochemical fluids and gases. In a few moments one must be able to stop the flow of fluid and to uncouple the pipes.

U.S. Pat. No. 3,558,161 describes a pipe connection device which comprises a plurality of jaws opportunely controlled by elastic rods connected with a hydraulic or mechanical type control system. The closing control leads said jaws to “get hold of” the flange of the pipe thus guaranteeing its watertightness.

The surface of the flange on which the jaw rests is normally flat and perpendicular to the longitudinal axis of the apparatus, so that during the uncoupling stage the moment of the force, caused by the friction between flange and jaw, which resists to the uncoupling increases progressively, in some case, even leading to compromise the same uncoupling, the latter being an absolutely not tolerable possibility in the extreme situations in which said coupling/uncoupling systems must operate.

This is also shown in DE-A-2833866.

In mathematical terms, for the uncoupling to occur, the product between the applied force R and its arm “a” (opening moment) must always be always greater than the product between the friction force Fₐ and its arm “b” (resistant moment). That is:

R*a>Fₐ*b

For the jaw to open such inequality must remain as such. It has however been verified that during the opening with flange having flat surface, the arm “a” decreases to the point that said inequality cannot be true any longer, in particular when the geometry of the jaw has been chosen in order as to resist strong loads.

Object of the present invention is to provide a flange conformed in such a way as to determine a jaw-flange connection that eliminates in simple and inexpensive way the aforesaid problem.

According to the invention such object is attained with a flange for pipes for the transport of petrochemical fluids, gases and liquefied gases, that it has a bearing surface for clamping jaw, which has a peripheral portion with a curved surface in the direction of support of the jaw.

In this way the progressive decrease of the arm “a” during the uncoupling stage is compensated by a variation in the force components that is in favour of the opening of the jaw.

These and other characteristics of the present invention will become evident from the following detailed description of an embodiment thereof that is illustrated as a non limiting example in the enclosed drawings, in which:

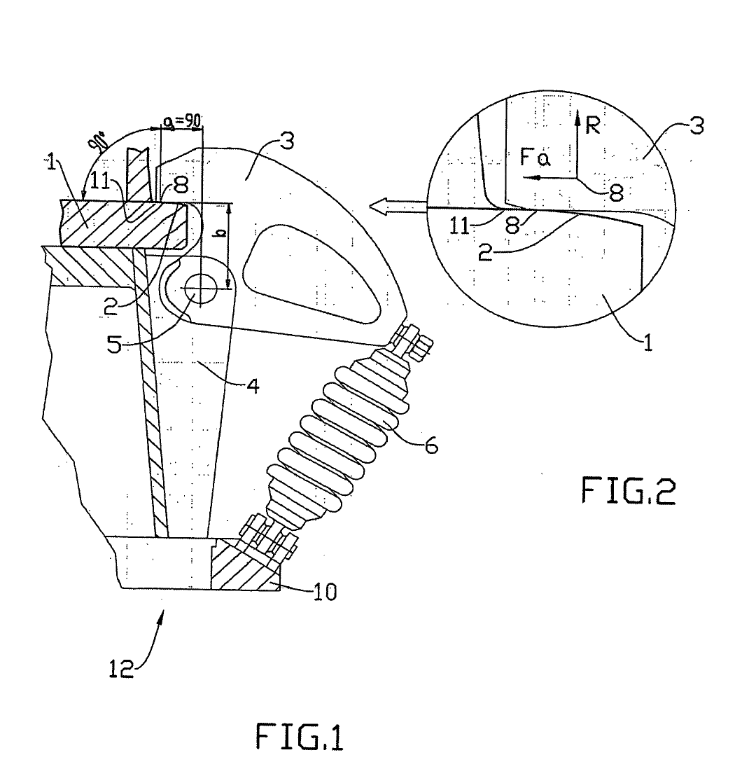

FIG. 1 shows a side view of the flange-jaw coupling according to the present invention in closing position;

FIG. 2 shows a side view in magnified scale of the flange-jaw coupling zone in FIG. 1;

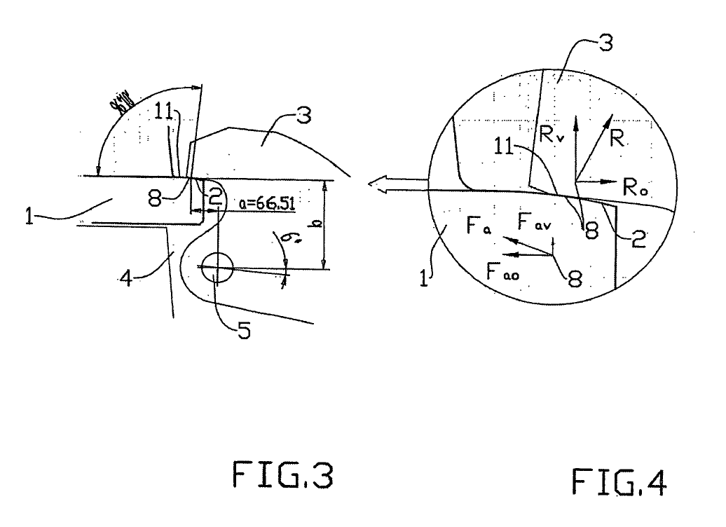

FIG. 3 shows a side view of the flange-jaw coupling with the jaw rotated by 6° in the opening sense;

FIG. 4 shows a side view in magnified scale of the flange-jaw coupling zone in FIG. 3;

FIG. 5 shows a side view of the flange-jaw coupling with the jaw rotated by 10° in the opening sense;

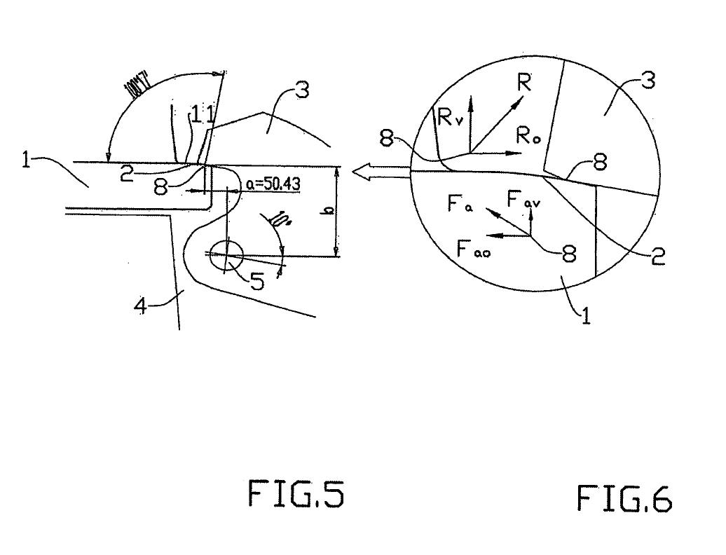

FIG. 6 shows a side view in magnified scale of the flange-jaw coupling zone in FIG. 5;

In the drawings a flange 1 comprises a surface 11 with curved peripheral portion 2 on which a jaw 3 rests which is hinged to a bracket 4 of a coupling for pipes 12 by means of a pin 5 as regards which it is free to rotate.

The movement of the jaw 3 is exerted by a spring 6 controlled to move between a closing position coplanar to the axis of the coupling to an opening position inclined as regards to it by the rotation of a ring or fifth wheel 10 opportunely controlled by hydraulic systems or the like.

The advantages of the present invention are identifiable by analysing the forces which interact in the flange-jaw contact zone 8 (FIGS. 2, 4, 6).

In FIGS. 1 and 2, which show purely exemplified values for “a” and “b”, the equilibrium equation is the following:

R*a=Fₐ*b

where:

R=force of contact between flange and jaw

Fₐ=force of friction generated by R (Fₐ=R×f, where f is the coefficient of friction between metals of the jaw flange coupling)

In order to make the jaw rotate in the opening sense, by applying the load R, it is necessary that: R*a>Fₐ*b

In the situation of FIGS. 3 and 4 the rotation of the jaw involved an inclination of Fₐ and R of which it is possible to distinguish the horizontal (Fₐₒ and Rₒ) and vertical (Fₐᵥ and Rᵥ) components.

In order for the jaw to open it is now necessary that:

(Rᵥ*a)+(Rₒ*b)>(Fₐₒ*b)−(Fₐᵥ*a)

As compared with the situation in FIG. 1-2 the left part of the disequation decreased by virtue of the decrease in the arm to (b remained equal), but such decrease is compensated by the reduction of the friction force Fₐₒ and by the generation of a vertical component Fₐᵥ favourable to the opening of the jaw 3, therefore the product between Fₐₒ and the b in FIG. 3-4 is smaller than the one between Fₐ and the b in FIG. 1-2.

If the contact surface of the flange had been flat, the product between Fₐ and b would have remained constant whereas the one between R and a would have been decreased because of the reduction of a, with the consequent risk of having at a certain point:

R*a<Fₐ*b

therefore the opening of the jaw could have been blocked.

In the situation of FIGS. 5-6 the jaw has been additionally rotated with the result that as compared with the case in FIG. 3-4 Fₐᵥ (component in favour of the opening) has increased whereas Fₐₒ (component which opposes to the opening) has decreased.

The disequation

(Rᵥ*a)+(Rₒ*b)>(Fₐₒ*b)−(Fₐᵥ*a)

is thus verified for the entire opening rotation of the jaw.

In short the profile of the flange is made as a function of the aforesaid disequation, with the aim to make it result always valid during the opening of the jaw 3.

1: Flange (1) for pipes for the transport of petrochemical fluids, gases and liquefied gases, characterised in that it has a bearing surface (11) for clamping jaw (3), which has a peripheral portion (2) bevelled in the direction of support of the jaw (3).

2: (canceled)

3: Flange according to claim 1, characterised in that the inequality (Rᵥ*a)+(Rₒ*b)>(Fₐₒ*b)−(Fₐᵥ*a) is always verified, where:
Rᵥ=vertical component of the applied force R;
a=arm of the vertical components of the forces;
Rₒ=horizontal component of the applied force R;
b=arm of the horizontal components of the forces;
Fₐₒ=horizontal component of the friction force Fₐ;
Fₐᵥ=vertical component of the friction force Fₐ.
